(19) United States
(12) Patent Application Publication
(10) Pub. No.: US 2026/0031893 A1
(43) Pub. Date: Jan. 29, 2026

(54) ANTENNA SELECTION PROCEDURE FOR TIME OF ARRIVAL ESTIMATION

(71) Applicant: QUALCOMM Incorporated, San Diego, CA (US)

(72) Inventors: Anand Srinivas GURUSWAMY, San Diego, CA (US); Damith Nivantha SENARATNE, San Diego, CA (US)

(21) Appl. No.: 18/781,934

(22) Filed: Jul. 23, 2024

(51) Int. Cl. H04B 7/08; G01S 13/76

(52) U.S. Cl. CPC H04B 7/0805; G01S 13/765

(57) ABSTRACT

This disclosure provides methods, components, devices and systems for antenna selection procedure for time of arrival estimation. Some aspects more specifically relate to antenna selection based on time-of-arrival (ToA) quality metrics and ToA values associated with packets received via multiple antennas. Some aspects provide that a first wireless device may receive one or more packets from a second wireless device and, for each received packet, obtain an instantaneous ToA quality metric for each antenna, which may be added the instantaneous ToA quality metric history for the associated antenna and second wireless device. The first wireless device may perform outlier rejection and averaging over a ToA quality metric history window, and may identify which antenna has a preferred averaged ToA quality metric. The first wireless device may identify an antenna from the selected antennas with the lowest ToA value and switch to the identified antenna for a ToA estimation procedure.

### TECHNICAL FIELD

This disclosure relates generally to wireless communication and, more specifically, to antenna selection procedure for time of arrival estimation.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in the disclosure can be implemented in a method for wireless communication performable by or at a first wireless device. The method may include receiving one or more packets from a second wireless device, measuring one or more time of arrival (ToA) quality metrics associated with each of the one or more packets for each of two or more antennas of the first wireless device, selecting one or more candidate antennas from the two or more antennas for a ToA measurement based on a candidate metric of each of the one or more candidate antennas, the candidate metric for each of the one or more candidate antennas based on the one or more ToA quality metrics and one or more prior ToA quality metrics from within a time window prior to receipt of the one or more packets, determining that a first antenna of the one or more candidate antennas has an earliest ToA for the one or more packets, and switching to the first antenna for the ToA measurement associated with the second wireless device based on the candidate metric of the first antenna exceeding a prior ToA quality metric of a different antenna of the two or more antennas by at least a threshold value.

One innovative aspect of the subject matter described in this disclosure can be implemented in a first wireless device for wireless communications. The first wireless device may include a processing system that includes processor circuitry and memory circuitry that stores code. The processing system may be configured to cause the first wireless device to receive one or more packets from a second wireless device, measure one or more ToA quality metrics associated with each of the one or more packets for each of two or more antennas of the first wireless device, select one or more candidate antennas from the two or more antennas for a ToA measurement based on a candidate metric of each of the one or more candidate antennas, the candidate metric for each of the one or more candidate antennas based on the one or more ToA quality metrics and one or more prior ToA quality metrics from within a time window prior to receipt of the one or more packets, determine that a first antenna of the one or more candidate antennas has an earliest ToA for the one or more packets, and switch to the first antenna for the ToA measurement associated with the second wireless device based on the candidate metric of the first antenna exceeding a prior ToA quality metric of a different antenna of the two or more antennas by at least a threshold value.

Another innovative aspect of the subject matter described in this disclosure can be implemented in another first wireless device for wireless communications. The first wireless device may include means for receiving one or more packets from a second wireless device, means for measuring one or more ToA quality metrics associated with each of the one or more packets for each of two or more antennas of the first wireless device, means for selecting one or more candidate antennas from the two or more antennas for a ToA measurement based on a candidate metric of each of the one or more candidate antennas, the candidate metric for each of the one or more candidate antennas based on the one or more ToA quality metrics and one or more prior ToA quality metrics from within a time window prior to receipt of the one or more packets, means for determining that a first antenna of the one or more candidate antennas has an earliest ToA for the one or more packets, and means for switching to the first antenna for the ToA measurement associated with the second wireless device based on the candidate metric of the first antenna exceeding a prior ToA quality metric of a different antenna of the two or more antennas by at least a threshold value.

Another innovative aspect of the subject matter described in this disclosure can be implemented in a non-transitory computer-readable medium storing code for wireless communications. The code may include instructions executable by one or more processors to receive one or more packets from a second wireless device, measure one or more ToA quality metrics associated with each of the one or more packets for each of two or more antennas of the first wireless device, select one or more candidate antennas from the two or more antennas for a ToA measurement based on a candidate metric of each of the one or more candidate antennas, the candidate metric for each of the one or more candidate antennas based on the one or more ToA quality metrics and one or more prior ToA quality metrics from within a time window prior to receipt of the one or more packets, determine that a first antenna of the one or more candidate antennas has an earliest ToA for the one or more packets, and switch to the first antenna for the ToA measurement associated with the second wireless device based on the candidate metric of the first antenna exceeding a prior ToA quality metric of a different antenna of the two or more antennas by at least a threshold value.

Some examples of the method, first wireless devices, and non-transitory computer-readable medium described herein may further include operations, features, means, or instructions for storing, prior to receipt of the one or more packets, the one or more prior ToA quality metrics, a time associated with each of the one or more prior ToA quality metrics, and an associated antenna of the two or more antennas, where one or more sets of prior ToA quality metrics may be associated with each of one or more other wireless devices for each of the two or more antennas at the first wireless device.

In some examples of the method, first wireless devices, and non-transitory computer-readable medium described herein, the measuring the one or more ToA quality metrics may include operations, features, means, or instructions for measuring, for each received packet of the one or more packets, an instantaneous ToA quality metric for each antenna of the two or more antennas of the first wireless device. In some examples of the method, first wireless devices, and non-transitory computer-readable medium described herein, the instantaneous ToA quality metric for each antenna includes one or more of a received signal strength indicator (RSSI), a channel impulse response (CIR) peak signal to interference and noise ratio (SINR), or a CIR first path SINR. In some examples of the method, first wireless devices, and non-transitory computer-readable medium described herein, the measuring the one or more ToA quality metrics may include operations, features, means, or instructions for adding the instantaneous ToA quality metric for each antenna to one or more prior ToA quality metrics for each of one or more other wireless devices including the second wireless device.

In some examples of the method, first wireless devices, and non-transitory computer-readable medium described herein, the selecting the one or more candidate antennas may include operations, features, means, or instructions for performing, for the ToA quality metrics associated with each antenna, outlier rejection and averaging of ToA quality metrics over the time window prior to receipt of the one or more packets, to obtain the candidate metric associated with the antenna. In some examples of the method, first wireless devices, and non-transitory computer-readable medium described herein, the outlier rejection and averaging may include operations, features, means, or instructions for identifying a median value of the ToA quality metrics within the time window, selecting a subset of samples from above and below the median value, and averaging the subset of samples to identify the candidate metric associated with the antenna. In some examples of the method, first wireless devices, and non-transitory computer-readable medium described herein, the selecting the one or more candidate antennas may include operations, features, means, or instructions for identifying a first candidate metric that may have a better metric value than other of the candidate metrics.

In some examples of the method, first wireless devices, and non-transitory computer-readable medium described herein, the selecting the one or more candidate antennas may include operations, features, means, or instructions for identifying each candidate metric that may be within a quality threshold value from the first candidate metric and selecting each antenna associated with each identified candidate metric as a candidate antenna. In some examples of the method, first wireless devices, and non-transitory computer-readable medium described herein, the determining that the first antenna of the one or more candidate antennas may have the earliest ToA for the one or more packets may include operations, features, means, or instructions for identifying ToA values associated with packets received using each of the candidate antenna and determining the first antenna may have the earliest ToA of the identified ToA values.

In some examples of the method, first wireless devices, and non-transitory computer-readable medium described herein, the switching to the first antenna may include operations, features, means, or instructions for identifying the prior ToA quality metric associated with a second antenna of the two or more antennas that was used for a prior ToA measurement, determining that the candidate metric of the first antenna exceeds the prior ToA quality metric of the second antenna by at least the threshold value, and switching to the first antenna for the ToA measurement. In some examples of the method, first wireless devices, and non-transitory computer-readable medium described herein, the second antenna may be used for the ToA measurement when the candidate metric of the first antenna does not exceed the prior ToA quality metric of the second antenna by at least the threshold value.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows a timing diagram illustrating an example process for performing a ranging operation.

FIG. 4 shows an example of a signaling diagram that supports antenna selection procedure for time of arrival estimation.

FIG. 5 shows an example of a process flow that supports antenna selection procedure for time of arrival estimation.

FIG. 6 shows a block diagram of an example wireless communication device that supports antenna selection procedure for time of arrival estimation.

FIG. 7 shows a flowchart illustrating an example process performable by or at a first wireless device that supports antenna selection procedure for time of arrival estimation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a first wireless device (such as a wireless station (STA), user equipment (UE), or vehicle to everything (V2X) device) and a second wireless device (such as a STA, UE, or access point (AP)) may perform communications (e.g., including an authentication procedure) via a first radio access technology (RAT), such as an ultra-wide band (UWB) connection. In some examples, the communications may be based on secure ranging, which may in some examples be provided by UWB modems that perform ranging by estimating a channel impulse response (CIR) from received packets, which is post-processed to estimate a time-of-arrival (ToA) of the received packets. Multiple ToAs obtained from one or more peers may be combined to obtain a time-of-flight (ToF) estimate, which may be used in secure ranging procedures. In some examples, UWB modem receivers may have multiple antennas and associated receive chains, and one or more antennas at a wireless device may provide more reliable ToA estimates than other antennas at the wireless device, and selection of one or more antennas of a set of available antennas may provide more reliable ToA estimations.

Various aspects relate generally to antenna selection for ToA estimation at a wireless device. Some aspects more specifically relate to antenna selection based on ToA quality metrics and ToA values associated with packets received via multiple antennas. In some examples, a first wireless device may have multiple antennas that may be used for ToA estimations, and may store an identification an antenna selected for ToA during one or more prior ToA estimations for one or more of the antennas. The one or more prior ToA estimations may also have an associated ToA quality metric, and a time of the estimation, which may be stored along with the identification of the antenna selected for ToA. In some examples, the first wireless device may receive one or more packets from a second wireless device and, for each received packet, obtain an instantaneous ToA quality metric for each antenna, which may be added the instantaneous ToA quality metric history for the associated antenna and second wireless device. In some examples, the ToA quality metric may be selected from multiple available ToA quality metrics. In some examples, the first wireless device may perform outlier rejection and averaging over a ToA quality metric history window, and may identify which antenna has a preferred averaged ToA quality metric. In some examples, the first wireless device may select all antennas whose ToA quality metric is within a threshold value of the identified antenna (such as within x dB of an antenna with a best ToA quality metric, where x may be configurable and tuned for each device model). In some examples, the first wireless device may identify an antenna from the selected antennas with the lowest ToA value and, if the ToA quality metric associated with this antenna exceeds the metric associated with the antenna used in the last measurement by a threshold amount (such as y dB), switch to the identified antenna for the ToA procedure, and otherwise continue using a prior antenna that was selected in a prior measurement.

Particular aspects of the subject matter described in this disclosure can be implemented to realize one or more of the following potential advantages. In some examples, by selecting an antenna with a relatively good ToA quality metric and a relatively low ToA value, the described techniques can be used to obtain ToA measurements in ranging operations based on both higher quality metrics and lower ToAs, which may enhance reliability of ToA measurements. Further, by providing multiple available ToA quality metrics, some aspects provide/enable flexibility in the choice of ToA quality metric. Additionally, in examples that use outlier rejection and averaging, the impact of noisy quality metric estimates and outliers may be reduced. In some further aspects, by providing a configurable threshold value for selecting antennas whose ToA quality metric is within a threshold value of an antenna with a best measured ToA quality metric, such aspects provide/enable the first wireless device to vary algorithm behavior smoothly between selections based on better ToA metrics and lower ToA values. In some even further aspects, by providing that the first wireless device switches antennas if a newly selected antenna has a ToA quality metric that exceeds a prior antenna ToA quality metric by a threshold value, such aspects provide/enable hysteresis to help prevent rapid antenna switching behavior.

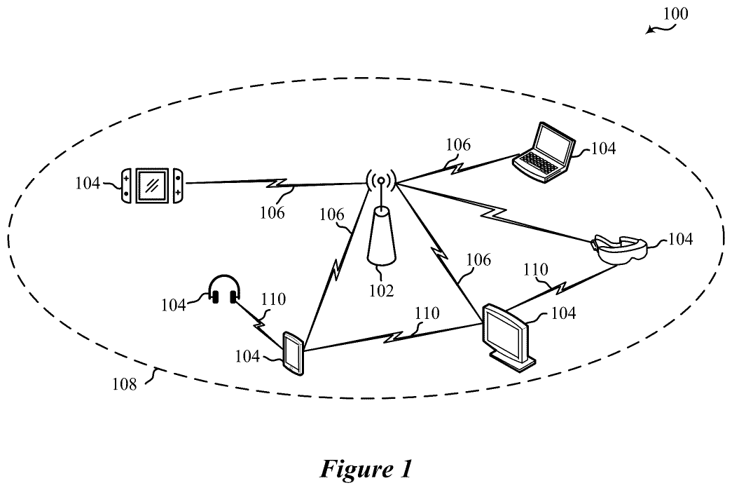

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHz), FR2 (24.25 GHz-52.6 GHz), FR3 (7.125 GHz-24.25 GHZ), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHZ portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHZ channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication devices (such as an AP 102 and STAs 104 described with reference to FIG. 1) may operate via one or more wireless communication links in a frequency band higher than a sub-7 GHZ (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (for example, a frequency band between 30 GHz and 300 GHz, such as a 60 GHz frequency band). A wireless communication system supporting such mmWave communications (such as AP 102 and STAs 104 in wireless communications network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

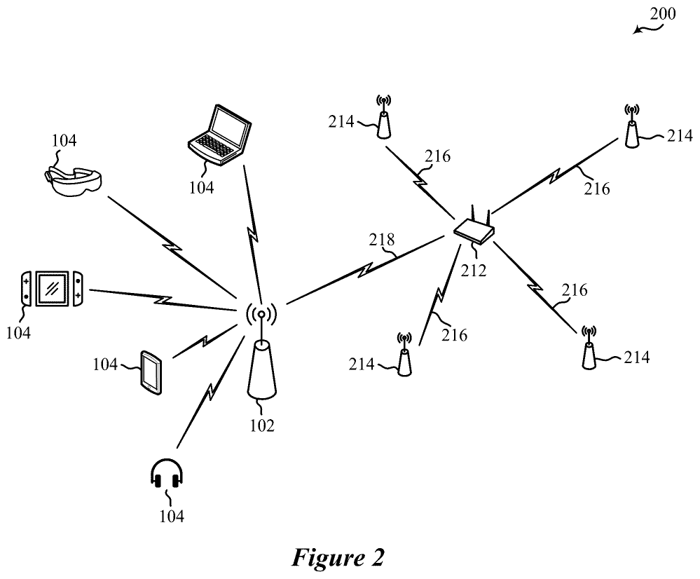

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 102, STAs 104, or both. The wireless communication devices 214 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (for example, audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (for example, cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices (such as the AP 102 or the STA 104) may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

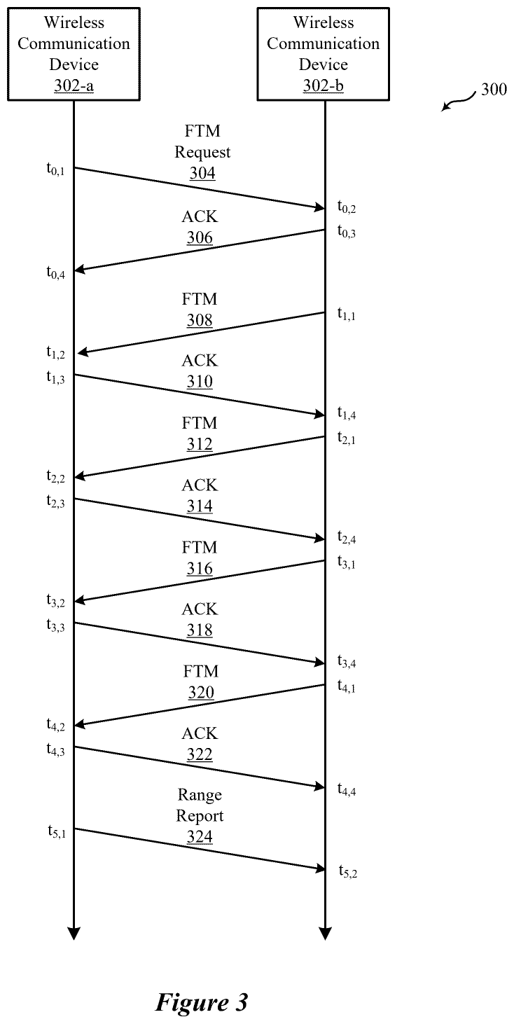

FIG. 3 shows a timing diagram illustrating an example process for performing a ranging operation 300. The process for the ranging operation 300 may be conjunctively performed by two wireless communication devices, such as a first wireless communication device 302-a and a second wireless communication device 302-b, in accordance with the IEEE 802.11REVme standards, which may each be an example of an AP 102 or a STA 104.

The ranging operation 300 may begin with the first wireless communication device 302-a transmitting an initial FTM range request frame 304 at time t_{0,1}. Responsive to successfully receiving the FTM range request frame 304 at time t_{0,2}, the second wireless communication device 302-b responds by transmitting a first ACK 306 at time t_{0,3}, which the first wireless communication device 302-a receives at time t_{0,4}. The first wireless communication device 302-a and the second wireless communication device 302-b exchange one or more FTM bursts, which may each include multiple exchanges of FTM action frames (hereinafter simply “FTM frames”) and corresponding ACKs. One or more of the FTM range request frame 304 and the FTM action frames (hereinafter simply “FTM frames”) may include FTM parameters specifying various characteristics of the ranging operation 300.

In the example shown in FIG. 3, in a first exchange, beginning at time t_{1,1}, the second wireless communication device 302-b transmits a first FTM frame 308. The second wireless communication device 302-b records the time t_{1,1} as the time of departure (TOD) of the first FTM frame 308. The first wireless communication device 302-a receives the first FTM frame 308 at time t_{1,2} and transmits a first acknowledgment frame (ACK) 310 to the second wireless communication device 302-b at time t_{1,3}. The first wireless communication device 302-a records the time t_{1,2} as the time of arrival (TOA) of the first FTM frame 308, and the time t_{1,3} as the TOD of the first ACK 310. The second wireless communication device 302-b receives the first ACK 310 at time t_{1,4} and records the time t_{1,4} as the TOA of the first ACK 310.

Similarly, in a second exchange, beginning at time t_{2,1}, the second wireless communication device 302-b transmits a second FTM frame 312. The second FTM frame 312 includes a first field indicating the TOD of the first FTM frame 308 and a second field indicating the TOA of the first ACK 310. The first wireless communication device 302-a receives the second FTM frame 312 at time t_{2,2} and transmits a second ACK 314 to the second wireless communication device 302-b at time t_{2,3}. The second wireless communication device 302-b receives the second ACK 314 at time t_{2,4}. Similarly, in a third exchange, beginning at time t_{3,1}, the second wireless communication device 302-b transmits a third FTM frame 316. The third FTM frame 316 includes a first field indicating the TOD of the second FTM frame 312 and a second field indicating the TOA of the second ACK 314. The first wireless communication device 302-a receives the third FTM frame 316 at time t_{3,2} and transmits a third ACK 318 to the second wireless communication device 302-b at time t_{3,3}. The second wireless communication device 302-b receives the third ACK 318 at time t_{3,4}. Similarly, in a fourth exchange, beginning at time t_{4,1}, the second wireless communication device 302-b transmits a fourth FTM frame 320. The fourth FTM frame 320 includes a first field indicating the TOD of the third FTM frame 316 and a second field indicating the TOA of the third ACK 318. The first wireless communication device 302-a receives the fourth FTM frame 320 at time t_{4,2} and transmits a fourth ACK 322 to the second wireless communication device 302-b at time t_{4,3}. The second wireless communication device 302-b receives the fourth ACK 322 at time t_{4,4}.

The first wireless communication device 302-a determines (for example, obtains, identifies, ascertains, calculates, or computes) a range indication in accordance with the TODs and TOAs. For example, in implementations or instances in which an FTM burst includes four exchanges of FTM frames, the first wireless communication device 302-a may determine (for example, obtain, identify, ascertain, calculate, or compute) a round trip time (RTT) between itself and the second wireless communication device III02-b in accordance with Equation 1.

$$R T T = \frac{1}{3} ( {\sum }_{k = 1}^{3} {t}_{4 , k} - {\sum }_{k = 1}^{3} {t}_{1 , k} ) - ( {\sum }_{k = 1}^{3} {t}_{3 , k} - {\sum }_{k = 1}^{3} {t}_{2 , k} ) \qquad ( 1 )$$

In some implementations, the range indication is the RTT. Additionally, or alternatively, in some implementations, the first wireless communication device 302-a may determine (for example, obtain, identify, ascertain, calculate, or compute) an actual approximate distance between itself and the second wireless communication device 302-b, for example, by multiplying the RTT by an approximate speed of light in the wireless medium. In such instances, the range indication may additionally, or alternatively, include the distance value. Additionally, or alternatively, the range indication may include an indication as to whether the second wireless communication device 302-b is within a proximity (for example, a service discovery threshold) of the first wireless communication device 302-a in accordance with the RTT. In some implementations, the first wireless communication device 302-a may transmit the range indication to the second wireless communication device 302-b, for example, in a range report 324 at time t_{5,1}, which the second wireless communication device receives at time t_{5,2}.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

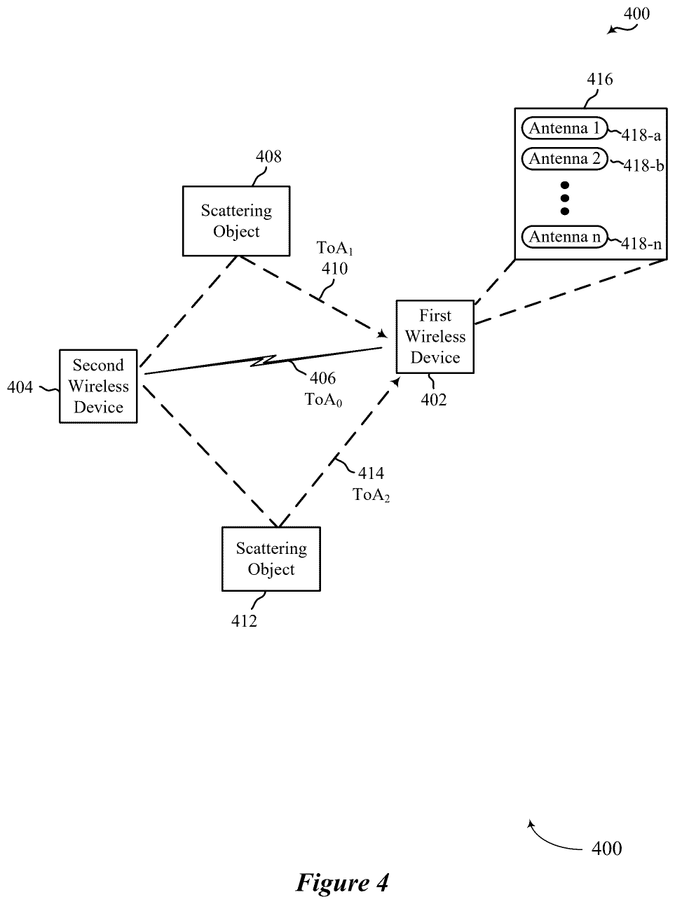

FIG. 4 shows an example of a signaling diagram 400 that supports antenna selection procedure for time of arrival estimation. In some examples, signaling diagram 400 may implement aspects of wireless communication network 100. For example, a first wireless device 402 and a second wireless device 404 may represent examples of STAs, such as the STAs 104 described with reference to FIG. 1. In some aspects, the first wireless device 404 may be an example of a UE or wearable (such as a smart watch) that performs proximity-based authentication with the second wireless device 404 (such as a wireless device associate with a lock).

In some examples, the first wireless device 402 may perform ToA estimations associated with ranging procedures with the second wireless device 404 (such as for UWB communications). The first wireless device 402 may also perform ToA estimations associated with ranging procedures with one or multiple other wireless devices, and a single second wireless device 404 is illustrated in FIG. 4 for purposes of discussion with the understanding that techniques discussed herein may be used for any number of second wireless devices 404. ToA estimations may be used on packets that are received at the first wireless device 402 from the second wireless device 404, which may be received in a direct RF path 406 which would have a lowest ToA value (such as ToA₀) due to having a shortest total path length, and one or more indirect RF paths that may include, for example, reflections off scattering objects. For example, a first scattering object 408 may result in a first indirect RF path 410 that has a higher ToA value (such as ToA₁) than ToA₀. Likewise, a second scattering object 412 may result in a second indirect RF path 414 that also has a higher ToA value (such as ToA₂) than ToA₀.

In some examples, the first wireless device 402 may an antenna module 416 that includes multiple antennas 418, including a first antenna 418-a, a second antenna 418-b, and one or more other antennas through nth antenna 418-n. In examples where the first wireless device 402 and the second wireless device 404 use UWB communications for secure ranging, the associated UWB modems may perform ranging by estimating a channel impulse response (CIR) from received packets, which is post-processed to estimate the ToA for the received packets. Multiple ToAs may be obtained from one or more peers and combined to obtain a time-of-flight (ToF) estimate for the secure ranging operations. When multiple antennas (and associated receive chains) are present, such as at the first wireless device 402, when these antennas are simultaneously enabled during reception, there are many ways to combine the information obtained from each antennas to compute the overall ToA estimate. For example, CIR combining may be used where the modem may phase-align and time-align the CIRs obtained from each antenna 418, combine them into a single CIR, and compute the ToA from the combined CIR. Other examples include ToA combining, where the modem may compute ToAs from each antenna 418 CIR separately, time-align them and combine the ToAs (such as by weighted averaging) to provide a final ToA estimate. Still other examples include antenna selection, where a single antenna may be selected based on some criteria (such as a received signal strength indicator (RSSI)) and report its ToA as the final ToA estimate. In some aspects, the first wireless device 402 may use the antenna selection techniques for ToA estimation, which may provide a relatively less complex implementation and thus use fewer processing resources than other ToA estimation techniques. However, the antenna selection techniques discussed herein may be used with any ToA estimation procedure in which fewer than all antennas of a wireless device are used to determine a ToA estimation.

When performing antenna selection, there are multiple criteria that can be used to determine one or more selected antennas. For example, the first wireless device 402 may select the antenna with a favorable ToA quality metric (such as a highest measured RSSI, a highest signal to interference and noise ratio (SINR), a highest SINR of antennas having an earliest received path, or others). In other examples, a device may simply select the antenna with the earliest detected path (such as an antenna with a lowest measured ToA value of one or more received packets) where, if the first path is weak on one antenna resulting in the selection of a secondary path as the line-of-sight (LOS) path, then selecting the other antenna which found the first path correctly may provide a more accurate ToA estimate. There are also other practical aspects that affect the choice of procedure for antenna selection, such as antenna beampattern/polarization characteristics, where UWB receiver designs may use an omnidirectional rim antenna along with one or more directional patch antennas, which may also be linearly polarized. As a result, each antenna may exhibit a different variation of gain as a function of the transmitters direction and orientation relative to the receiver doe to orientation effect on polarization. This means that in some scenarios the antennas may have comparable RSSIs, while in other cases they may differ significantly. Another practical aspect that affects the choice of procedure for antenna selection is the benefit of stable ToA estimates, and if a chain selection procedure rapidly switches its selection on a per-packet basis, then the ToA variation may increase due to angle-of-arrival (AoA)-dependent arrival time difference between different antennas. Hence it may be desirable to switch the selected antenna infrequently and only if such a switch would provide a meaningful improvement to ToA estimations. Another practical aspect that affects the choice of procedure for antenna selection is potential instability of ToA quality metrics. For example, a ToA quality metric may exhibit significant packet-to-packet variation due to factors such as the presence of interferers or multipath environments. Thus, it may be desirable to have a mechanism to smooth out the ToA quality metric to avoid the problems associated with rapid chain switching as described.

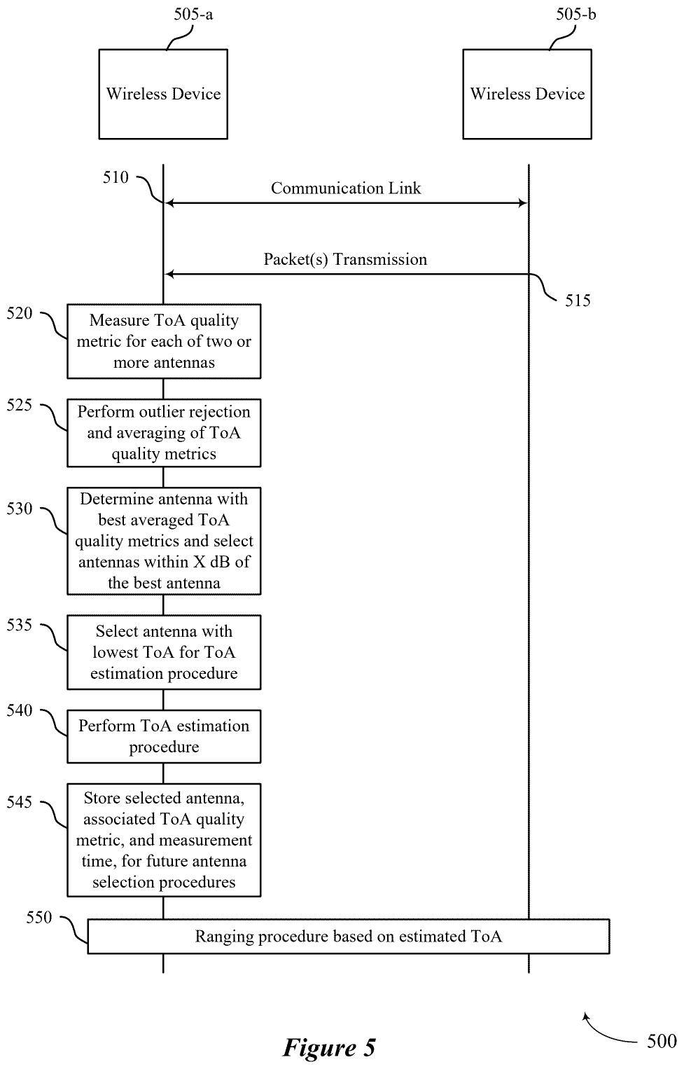

In accordance with various aspects, techniques are provided for antenna selection based on ToA quality metrics and ToA values associated with packets received via multiple antennas at the first wireless device 402. Various examples of such techniques are discussed with reference to FIG. 5, which may provide one or more of flexibility of selecting ToA quality metrics, outlier rejection and averaging of ToA quality metrics, the ability to vary algorithm behavior smoothly between a bias towards a favorable ToA metric (such as RSSI or SINR) or a favorable ToA value (such as a lowest ToA value), and a hysteresis parameter that may to prevent rapid antenna switching.

FIG. 5 shows an example of a process flow 500 that supports antenna selection procedure for time of arrival estimation. In some examples, process flow 500 may implement aspects of, or be implemented by aspects of, the wireless communication network 100 or the signaling diagram 400. For example, a first wireless device 505-a may be an example of the first wireless device 402, and a second wireless device 505-b may be an example of the second wireless device 404 as described with reference to FIG. 4.

At 510, the first wireless device 505-a and the second wireless device 505-b may establish a communication link over which wireless communications may be performed. In some examples, the communication link may be via a first RAT, such as UWB, and the first wireless device 505-a and the second wireless device 505-b may perform secure ranging as part of the wireless communications. Such secure ranging may be performed, for example, as discussed with reference to the ranging operation 300 of FIG. 3, in accordance with the IEEE 802.11REVme standards.

At 515, the second wireless device 505-b may transmit, and the first wireless device 505-a may receive, via the first RAT, a one or more packets (such as packets associated with one or more FTM frames).

At 520, the first wireless device 505-a may measure a ToA quality metric for each of two or more antennas of the first wireless device. In some aspects, for each received packet, the first wireless device 505-a may obtain an instantaneous ToA quality metric for each antenna, using RSSI, SINR (such as CIR Peak SINR, CIR first path SINR), or another signal strength metric (such as received power values, ratios of received energy versus interference energy, among others). In some examples, the first wireless device 505-a may select the ToA quality metric to use, such as based on recently observed variability in the ToA quality metrics, or a state of the first wireless device 505-a (such as a speed at which the first wireless device 505-a is moving), to provide just two examples.

In some aspects, the first wireless device 505-a may, for each associated peer device, store the antenna selected for ToA during a most recent measurement and a history of past ToA quality metric measurements along with the time at which they were measured for all enabled antennas. In such aspects, the first wireless device 505-a may add the new instantaneous ToA quality metric to the past ToA quality metric history for the relevant peer (the second wireless device 505-b, in this example).

At 525, the first wireless device 505-a may perform outlier rejection and averaging of ToA quality metrics. In some examples, the first wireless device 505-a may analyze a set of ToA quality metrics from a history window (such as the prior 500 ms), remove any outlier metric values (such as a value that deviates significantly from an average metric value), and average remaining metric values, for each antenna. In one example, the first wireless device 505-a may find a median ToA quality metric value over the history window, select a few samples to the left and right of the median, and average the selected samples. Such outlier rejection and averaging may help to reduce the impact of noisy ToA quality metric estimates and outliers, and provide a more stable comparison for ToA quality metrics.

At 530, the first wireless device 505-a may determine an antenna with a favorable average ToA quality metric and select any antennas with an averaged ToA quality metric that is within a threshold value of the determined antenna. In some examples, the first wireless device 505-a may find the antenna with the best averaged ToA quality metric, and select all antennas whose ToA quality metric is within x dB of the best antenna, where x may be configurable and may be tuned for each device model. Providing such a configurable threshold value may allow the first wireless device 505-a to bias antenna selection between antennas with a better ToA metrics and all antennas. For example, the parameter x may be adjusted to smoothly shift the algorithm behavior from best ToA quality metric based selection (such as for x=0 dB) to a lowest ToA based selection (x=100 dB). Intermediate values of x may offer a good tradeoff for selection an antenna with the lowest ToA among all antenna with relatively good ToA quality metrics.

At 535, the first wireless device 505-a may select an antenna with a lowest ToA value from the selected antennas. In some examples, the first wireless device 505-a may switch to the antenna with the lowest ToA value only if the averaged ToA quality metric associated with this antenna exceeds the ToA quality metric associated with an antenna used in a most recent ToA estimation by a threshold value (such as y dB, where y is configurable), and may otherwise continue using the antenna selected in the most recent ToA estimation for the second wireless device 505-b. Such a threshold value for an antenna switch provides a hysteresis parameter, y, that prevents rapid antenna switching behavior. For example, if only two antennas are present, Ant₀ and Ant₁, and Ant₀ is initially selected, for y=3 dB, the first wireless device 505-a may select Ant₁ only if its averaged ToA quality metric exceeds that of Ant₀ by 3 dB. After switching to Ant₁, the first wireless device 505-a will switch back to Ant₀ only if Ant₀ exceeds Ant₁'s ToA quality metric by 3 dB again, which would require a significant change in the environment (such as the first wireless device 505-a and the second wireless device 505-b moving significantly relative to one another).

At 540, the first wireless device 505-a may perform the ToA estimation procedure. At 545, the first wireless device 505-a may store the selected antenna, associated ToA quality metric, and measurement time, for future antenna selection procedures. At 550, the first wireless device 505-a may and the second wireless device 505-b may perform a ranging procedure based on the estimated ToA, as part of the communications between the first wireless device 505-a and the second wireless device 505-b.

In some examples, the first wireless device 402 may have multiple antennas that may be used for ToA estimations, and may store an identification an antenna selected for ToA during one or more prior ToA estimations for one or more of the antennas. The one or more prior ToA estimations may also have an associated ToA quality metric, and a time of the estimation, which may be stored along with the identification of the antenna selected for ToA. In some examples, the first wireless device may receive one or more packets from a second wireless device and, for each received packet, obtain an instantaneous ToA quality metric for each antenna, which may be added the instantaneous ToA quality metric history for the associated antenna and second wireless device. In some examples, the ToA quality metric may be selected from multiple available ToA quality metrics. In some examples, the first wireless device may perform outlier rejection and averaging over a ToA quality metric history window, and may identify which antenna has a preferred averaged ToA quality metric. In some examples, the first wireless device may select all antennas whose ToA quality metric is within a threshold value of the identified antenna (such as within x dB of an antenna with a best ToA quality metric, where x may be configurable and tuned for each device model). In some examples, the first wireless device may identify an antenna from the selected antennas with the lowest ToA value and, if the ToA quality metric associated with this antenna exceeds the metric associated with the antenna used in the last measurement by a threshold amount (such as y dB), switch to the identified antenna for the ToA procedure, and otherwise continue using a prior antenna that was selected in a prior measurement.

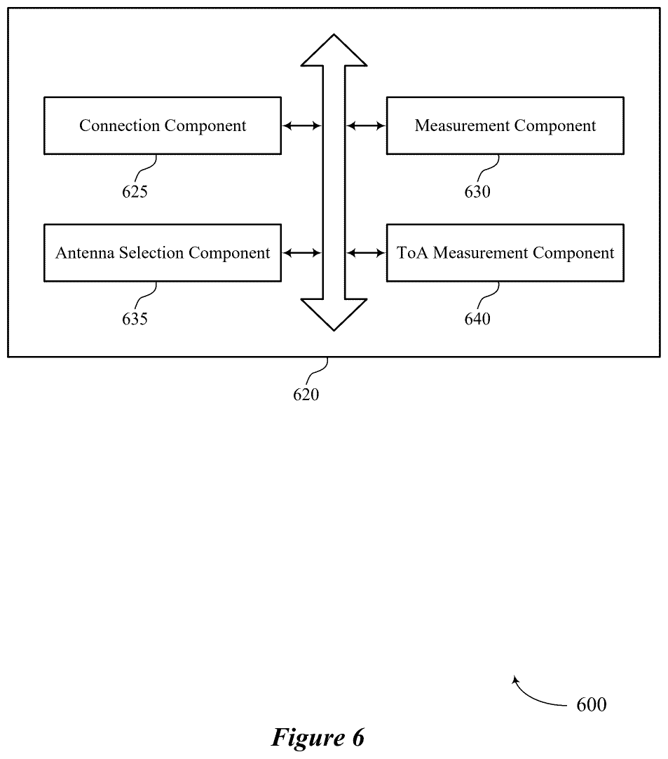

FIG. 6 shows a block diagram 600 of a wireless device 620 that supports antenna selection procedure for time of arrival estimation in accordance with one or more aspects of the present disclosure. The wireless device 620 may be an example of aspects of a wireless device as described with reference to FIGS. 2 through 5. The wireless device 620, or various components thereof, may be an example of means for performing various aspects of antenna selection procedure for time of arrival estimation as described herein. For example, the wireless device 620 may include a connection component 625, a measurement component 630, an antenna selection component 635, a ToA measurement component 640, or any combination thereof. Each of these components, or components or subcomponents thereof (e.g., one or more processors, one or more memories), may communicate, directly or indirectly, with one another (e.g., via one or more buses).

The wireless communication device 620 may support wireless communication in accordance with examples as disclosed herein. The connection component 625 is configurable or configured to receive one or more packets from a second wireless device. The measurement component 630 is configurable or configured to measure one or more time of arrival (ToA) quality metrics associated with each of the one or more packets for each of two or more antennas of the first wireless device. The antenna selection component 635 is configurable or configured to select one or more candidate antennas from the two or more antennas for a ToA measurement based on a candidate metric of each of the one or more candidate antennas, the candidate metric for each of the one or more candidate antennas based on the one or more ToA quality metrics and one or more prior ToA quality metrics from within a time window prior to receipt of the one or more packets. In some examples, the antenna selection component 635 is configurable or configured to determine that a first antenna of the one or more candidate antennas has an earliest ToA for the one or more packets. The ToA measurement component 640 is configurable or configured to switch to the first antenna for the ToA measurement associated with the second wireless device based on the candidate metric of the first antenna exceeding a prior ToA quality metric of a different antenna of the two or more antennas by at least a threshold value.

In some examples, the measurement component 630 is configurable or configured to store, prior to receipt of the one or more packets, the one or more prior ToA quality metrics, a time associated with each of the one or more prior ToA quality metrics, and an associated antenna of the two or more antennas, where one or more sets of prior ToA quality metrics are associated with each of one or more other wireless devices for each of the two or more antennas at the first wireless device.

In some examples, to support measuring the one or more ToA quality metrics, the measurement component 630 is configurable or configured to measure, for each received packet of the one or more packets, an instantaneous ToA quality metric for each antenna of the two or more antennas of the first wireless device.

In some examples, the instantaneous ToA quality metric for each antenna includes one or more of a received signal strength indicator (RSSI), a channel impulse response (CIR) peak signal to interference and noise ratio (SINR), or a CIR first path SINR.

In some examples, to support measuring the one or more ToA quality metrics, the measurement component 630 is configurable or configured to add the instantaneous ToA quality metric for each antenna to one or more prior ToA quality metrics for each of one or more other wireless devices including the second wireless device.

In some examples, to support selecting the one or more candidate antennas, the antenna selection component 635 is configurable or configured to perform, for the ToA quality metrics associated with each antenna, outlier rejection and averaging of ToA quality metrics over the time window prior to receipt of the one or more packets, to obtain the candidate metric associated with the antenna.

In some examples, to support outlier rejection and averaging, the antenna selection component 635 is configurable or configured to identify a median value of the ToA quality metrics within the time window. In some examples, to support outlier rejection and averaging, the antenna selection component 635 is configurable or configured to select a subset of samples from above and below the median value. In some examples, to support outlier rejection and averaging, the antenna selection component 635 is configurable or configured to average the subset of samples to identify the candidate metric associated with the antenna.

In some examples, to support selecting the one or more candidate antennas, the antenna selection component 635 is configurable or configured to identify a first candidate metric that has a better metric value than other of the candidate metrics.

In some examples, to support selecting the one or more candidate antennas, the antenna selection component 635 is configurable or configured to identify each candidate metric that is within a quality threshold value from the first candidate metric. In some examples, to support selecting the one or more candidate antennas, the antenna selection component 635 is configurable or configured to select each antenna associated with each identified candidate metric as a candidate antenna.

In some examples, to support determining that the first antenna of the one or more candidate antennas has the earliest ToA for the one or more packets, the antenna selection component 635 is configurable or configured to identify ToA values associated with packets received using each of the candidate antenna. In some examples, to support determining that the first antenna of the one or more candidate antennas has the earliest ToA for the one or more packets, the antenna selection component 635 is configurable or configured to determine the first antenna has the earliest ToA of the identified ToA values.

In some examples, to support switching to the first antenna, the ToA measurement component 640 is configurable or configured to identify the prior ToA quality metric associated with a second antenna of the two or more antennas that was used for a prior ToA measurement. In some examples, to support switching to the first antenna, the ToA measurement component 640 is configurable or configured to determine that the candidate metric of the first antenna exceeds the prior ToA quality metric of the second antenna by at least the threshold value. In some examples, to support switching to the first antenna, the ToA measurement component 640 is configurable or configured to switch to the first antenna for the ToA measurement.

In some examples, the second antenna is used for the ToA measurement when the candidate metric of the first antenna does not exceed the prior ToA quality metric of the second antenna by at least the threshold value.

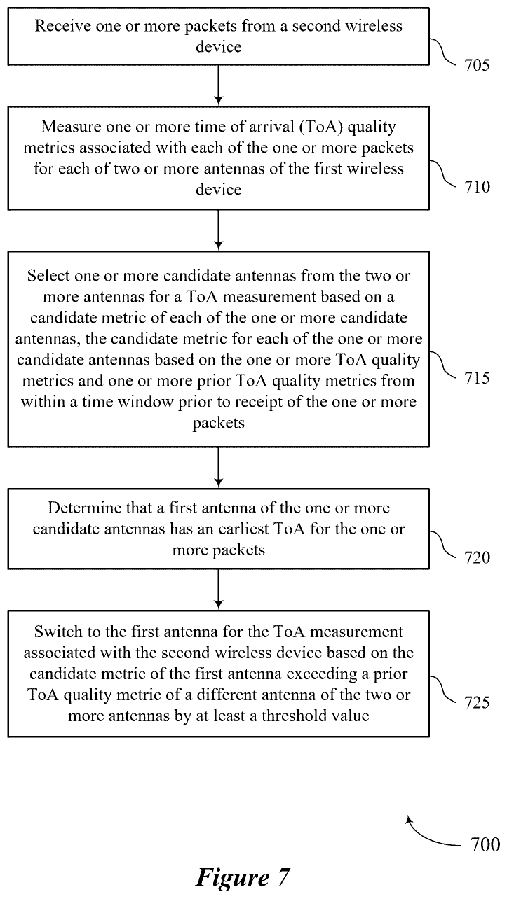

FIG. 7 shows a flowchart illustrating a method 700 that supports antenna selection procedure for time of arrival estimation in accordance with one or more aspects of the present disclosure. The operations of the method 700 may be implemented by a wireless device or its components as described herein. For example, the operations of the method 700 may be performed by a wireless device as described with reference to FIGS. 2 through 6. In some examples, a wireless device may execute a set of instructions to control the functional elements of the wireless device to perform the described functions. Additionally, or alternatively, the wireless device may perform aspects of the described functions using special-purpose hardware.

At 705, the method may include receiving one or more packets from a second wireless device. The operations of 705 may be performed in accordance with examples as disclosed herein. In some examples, aspects of the operations of 705 may be performed by a connection component 625 as described with reference to FIG. 6.

At 710, the method may include measuring one or more time of arrival (ToA) quality metrics associated with each of the one or more packets for each of two or more antennas of the first wireless device. The operations of 710 may be performed in accordance with examples as disclosed herein. In some examples, aspects of the operations of 710 may be performed by a measurement component 630 as described with reference to FIG. 6.

At 715, the method may include selecting one or more candidate antennas from the two or more antennas for a ToA measurement based on a candidate metric of each of the one or more candidate antennas, the candidate metric for each of the one or more candidate antennas based on the one or more ToA quality metrics and one or more prior ToA quality metrics from within a time window prior to receipt of the one or more packets. The operations of 715 may be performed in accordance with examples as disclosed herein. In some examples, aspects of the operations of 715 may be performed by an antenna selection component 635 as described with reference to FIG. 6.

At 720, the method may include determining that a first antenna of the one or more candidate antennas has an earliest ToA for the one or more packets. The operations of 720 may be performed in accordance with examples as disclosed herein. In some examples, aspects of the operations of 720 may be performed by an antenna selection component 635 as described with reference to FIG. 6.

At 725, the method may include switching to the first antenna for the ToA measurement associated with the second wireless device based on the candidate metric of the first antenna exceeding a prior ToA quality metric of a different antenna of the two or more antennas by at least a threshold value. The operations of 725 may be performed in accordance with examples as disclosed herein. In some examples, aspects of the operations of 725 may be performed by a ToA measurement component 640 as described with reference to FIG. 6.

Implementation examples are described in the following numbered clauses:

Aspect 1: A method for wireless communication at a first wireless device, comprising: receiving one or more packets from a second wireless device; measuring one or more ToA quality metrics associated with each of the one or more packets for each of two or more antennas of the first wireless device; selecting one or more candidate antennas from the two or more antennas for a ToA measurement based at least in part on a candidate metric of each of the one or more candidate antennas, the candidate metric for each of the one or more candidate antennas based at least in part on the one or more ToA quality metrics and one or more prior ToA quality metrics from within a time window prior to receipt of the one or more packets; determining that a first antenna of the one or more candidate antennas has an earliest ToA for the one or more packets; and switching to the first antenna for the ToA measurement associated with the second wireless device based at least in part on the candidate metric of the first antenna exceeding a prior ToA quality metric of a different antenna of the two or more antennas by at least a threshold value.

Aspect 2: The method of aspect 1, further comprising: storing, prior to receipt of the one or more packets, the one or more prior ToA quality metrics, a time associated with each of the one or more prior ToA quality metrics, and an associated antenna of the two or more antennas, wherein one or more sets of prior ToA quality metrics are associated with each of one or more other wireless devices for each of the two or more antennas at the first wireless device.

Aspect 3: The method of any of aspects 1 through 2, wherein the measuring the one or more ToA quality metrics comprises: measuring, for each received packet of the one or more packets, an instantaneous ToA quality metric for each antenna of the two or more antennas of the first wireless device.

Aspect 4: The method of aspect 3, wherein the instantaneous ToA quality metric for each antenna includes one or more of a RSSI, a CIR peak SINR, or a CIR first path SINR.

Aspect 5: The method of any of aspects 3 through 4, wherein the measuring the one or more ToA quality metrics further comprises: adding the instantaneous ToA quality metric for each antenna to one or more prior ToA quality metrics for each of one or more other wireless devices including the second wireless device.

Aspect 6: The method of any of aspects 1 through 5, wherein the selecting the one or more candidate antennas further comprises: performing, for the ToA quality metrics associated with each antenna, outlier rejection and averaging of ToA quality metrics over the time window prior to receipt of the one or more packets, to obtain the candidate metric associated with the antenna.

Aspect 7: The method of aspect 6, wherein the outlier rejection and averaging comprises: identifying a median value of the ToA quality metrics within the time window; selecting a subset of samples from above and below the median value; and averaging the subset of samples to identify the candidate metric associated with the antenna.

Aspect 8: The method of any of aspects 6 through 7, wherein the selecting the one or more candidate antennas further comprises: identifying a first candidate metric that has a better metric value than other of the candidate metrics.

Aspect 9: The method of aspect 8, wherein the selecting the one or more candidate antennas further comprises: identifying each candidate metric that is within a quality threshold value from the first candidate metric; and selecting each antenna associated with each identified candidate metric as a candidate antenna.

Aspect 10: The method of aspect 9, wherein the determining that the first antenna of the one or more candidate antennas has the earliest ToA for the one or more packets comprises: identifying ToA values associated with packets received using each of the candidate antenna; and determining the first antenna has the earliest ToA of the identified ToA values.

Aspect 11: The method of any of aspects 1 through 10, wherein the switching to the first antenna comprises: identifying the prior ToA quality metric associated with a second antenna of the two or more antennas that was used for a prior ToA measurement; determining that the candidate metric of the first antenna exceeds the prior ToA quality metric of the second antenna by at least the threshold value; and switching to the first antenna for the ToA measurement.

Aspect 12: The method of aspect 11, wherein the second antenna is used for the ToA measurement when the candidate metric of the first antenna does not exceed the prior ToA quality metric of the second antenna by at least the threshold value.

Aspect 13: A first wireless device for wireless communication, comprising a processing system that includes processor circuitry and memory circuitry that stores code, the processing system configured to cause the first wireless device to perform a method of any of aspects 1 through 12.

Aspect 14: A first wireless device for wireless communication, comprising at least one means for performing a method of any of aspects 1 through 12.

Aspect 15: A non-transitory computer-readable medium storing code for wireless communication, the code comprising instructions executable by one or more processors to perform a method of any of aspects 1 through 12.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
receive one or more packets from a second wireless device;
measure one or more time of arrival (ToA) quality metrics associated with each of the one or more packets for each of two or more antennas of the first wireless device;
select one or more candidate antennas from the two or more antennas for a ToA measurement based at least in part on a candidate metric of each of the one or more candidate antennas, the candidate metric for each of the one or more candidate antennas based at least in part on the one or more ToA quality metrics and one or more prior ToA quality metrics from within a time window prior to receipt of the one or more packets;
determine that a first antenna of the one or more candidate antennas has an earliest ToA for the one or more packets; and
switch to the first antenna for the ToA measurement associated with the second wireless device based at least in part on the candidate metric of the first antenna exceeding a prior ToA quality metric of a different antenna of the two or more antennas by at least a threshold value.

2. The first wireless device of claim 1, wherein the processing system is further configured to cause the first wireless device to:
store, prior to receipt of the one or more packets, the one or more prior ToA quality metrics, a time associated with each of the one or more prior ToA quality metrics, and an associated antenna of the two or more antennas, wherein one or more sets of prior ToA quality metrics are associated with each of one or more other wireless devices for each of the two or more antennas at the first wireless device.

3. The first wireless device of claim 1, wherein, to measure the one or more ToA quality metrics, the processing system is configured to cause the first wireless device to:
measure, for each received packet of the one or more packets, an instantaneous ToA quality metric for each antenna of the two or more antennas of the first wireless device.

4. The first wireless device of claim 3, wherein the instantaneous ToA quality metric for each antenna includes one or more of a received signal strength indicator (RSSI), a channel impulse response (CIR) peak signal to interference and noise ratio (SINR), or a CIR first path SINR.

5. The first wireless device of claim 3, wherein, to measure the one or more ToA quality metrics, the processing system is further configured to cause the first wireless device to:
add the instantaneous ToA quality metric for each antenna to one or more prior ToA quality metrics for each of one or more other wireless devices including the second wireless device.

6. The first wireless device of claim 1, wherein, to select the one or more candidate antennas, the processing system is further configured to cause the first wireless device to:
perform, for the ToA quality metrics associated with each antenna, outlier rejection and averaging of ToA quality metrics over the time window prior to receipt of the one or more packets, to obtain the candidate metric associated with the antenna.

7. The first wireless device of claim 6, wherein, to perform outlier rejection and averaging, the processing system is configured to cause the first wireless device to:
identify a median value of the ToA quality metrics within the time window;
select a subset of samples from above and below the median value; and
average the subset of samples to identify the candidate metric associated with the antenna.

8. The first wireless device of claim 6, wherein, to select the one or more candidate antennas, the processing system is further configured to cause the first wireless device to:
identify a first candidate metric that has a better metric value than other of the candidate metrics.

9. The first wireless device of claim 8, wherein, to select the one or more candidate antennas, the processing system is further configured to cause the first wireless device to:
identify each candidate metric that is within a quality threshold value from the first candidate metric; and
select each antenna associated with each identified candidate metric as a candidate antenna.

10. The first wireless device of claim 9, wherein, to determine that the first antenna of the one or more candidate antennas has the earliest ToA for the one or more packets, the processing system is configured to cause the first wireless device to:
identify ToA values associated with packets received using each of the candidate antenna; and
determine the first antenna has the earliest ToA of the identified ToA values.

11. The first wireless device of claim 1, wherein, to switch to the first antenna, the processing system is configured to cause the first wireless device to:
identify the prior ToA quality metric associated with a second antenna of the two or more antennas that was used for a prior ToA measurement;
determine that the candidate metric of the first antenna exceeds the prior ToA quality metric of the second antenna by at least the threshold value; and
switch to the first antenna for the ToA measurement.

12. The first wireless device of claim 11, wherein the second antenna is used for the ToA measurement when the candidate metric of the first antenna does not exceed the prior ToA quality metric of the second antenna by at least the threshold value.

13. A method for wireless communication at a first wireless device, comprising:
receiving one or more packets from a second wireless device;
measuring one or more time of arrival (ToA) quality metrics associated with each of the one or more packets for each of two or more antennas of the first wireless device;
selecting one or more candidate antennas from the two or more antennas for a ToA measurement based at least in part on a candidate metric of each of the one or more candidate antennas, the candidate metric for each of the one or more candidate antennas based at least in part on the one or more ToA quality metrics and one or more prior ToA quality metrics from within a time window prior to receipt of the one or more packets;
determining that a first antenna of the one or more candidate antennas has an earliest ToA for the one or more packets; and
switching to the first antenna for the ToA measurement associated with the second wireless device based at least in part on the candidate metric of the first antenna exceeding a prior ToA quality metric of a different antenna of the two or more antennas by at least a threshold value.

14. The method of claim 13, further comprising:
storing, prior to receipt of the one or more packets, the one or more prior ToA quality metrics, a time associated with each of the one or more prior ToA quality metrics, and an associated antenna of the two or more antennas, wherein one or more sets of prior ToA quality metrics are associated with each of one or more other wireless devices for each of the two or more antennas at the first wireless device.

15. The method of claim 13, wherein the selecting the one or more candidate antennas further comprises:
performing, for the ToA quality metrics associated with each antenna, outlier rejection and averaging of ToA quality metrics over the time window prior to receipt of the one or more packets, to obtain the candidate metric associated with the antenna.

16. The method of claim 15, wherein the selecting the one or more candidate antennas further comprises:
identifying a first candidate metric that has a better metric value than other of the candidate metrics.

17. The method of claim 16, wherein the selecting the one or more candidate antennas further comprises:
identifying each candidate metric that is within a quality threshold value from the first candidate metric; and
selecting each antenna associated with each identified candidate metric as a candidate antenna.

18. The method of claim 17, wherein the determining that the first antenna of the one or more candidate antennas has the earliest ToA for the one or more packets comprises:
identifying ToA values associated with packets received using each of the candidate antenna; and
determining the first antenna has the earliest ToA of the identified ToA values.

19. The method of claim 13, wherein the switching to the first antenna comprises:
identifying the prior ToA quality metric associated with a second antenna of the two or more antennas that was used for a prior ToA measurement;
determining that the candidate metric of the first antenna exceeds the prior ToA quality metric of the second antenna by at least the threshold value; and
switching to the first antenna for the ToA measurement.

20. A first wireless device for wireless communication, comprising:
means for receiving one or more packets from a second wireless device;
means for measuring one or more time of arrival (ToA) quality metrics associated with each of the one or more packets for each of two or more antennas of the first wireless device;
means for selecting one or more candidate antennas from the two or more antennas for a ToA measurement based at least in part on a candidate metric of each of the one or more candidate antennas, the candidate metric for each of the one or more candidate antennas based at least in part on the one or more ToA quality metrics and one or more prior ToA quality metrics from within a time window prior to receipt of the one or more packets;
means for determining that a first antenna of the one or more candidate antennas has an earliest ToA for the one or more packets; and
means for switching to the first antenna for the ToA measurement associated with the second wireless device based at least in part on the candidate metric of the first antenna exceeding a prior ToA quality metric of a different antenna of the two or more antennas by at least a threshold value.
